(19) United States
(12) Patent Application Publication
(10) Pub. No.: US 2011/0025837 A1
(43) Pub. Date: Feb. 3, 2011

(54) METHOD OF IMAGING A SAMPLE

(75) Inventors: Dirk Vossen, Eindhoven (NL); Levinus Bakker, Shangahi (CN); Bas Hulsken, Eindhoven (NL); Sjoerd Stallinga, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/672,551

(22) PCT Filed: Aug. 12, 2008
(86) PCT No.: PCT/IB2008/053218

§ 371 Date: Feb. 8, 2010

(30) Foreign Application Priority Data
Aug. 16, 2007 (EP) 07301309.6

(51) Int. Cl. G06K 9/60; H04N 7/18

(52) U.S. Cl. 348/79; 382/284; 348/E07.085

(57) ABSTRACT

A method of imaging a sample comprises the steps of: -providing S1 a reference array of spots 104, -illuminating the sample 106 with the reference array of spots 104 and acquiring S2 at least one sample image IM_{Si} comprising a sample related array of spots 107 resulting from the reference array of spots interacting with the sample 106, -determining S3 a spot characterizing parameter for each of a plurality of sample related spots, and -constructing S4 an image of the sample IM, By plotting the spot characterizing parameter for each of the plurality of sample related spots at the respective sample related spot position.

### FIELD OF THE INVENTION

An aspect of the invention relates to an image processing method, more precisely to a method of imaging a sample. Another aspect of the invention relates to an application of said method to multi-spot scanning microscopes. A further aspect of the invention relates to a computer program product for implementing the method of imaging a sample.

### BACKGROUND OF THE INVENTION

Various techniques of optical microscopy are known in the art.

Firstly, some microscopes use objective lens being aberration-free, having a large field of view and having an important numerical aperture. However, such microscopes are expensive.

Secondly, scanning microscopes form images by scanning the focus of the objective lens with respect to the sample to be measured or vice-versa. Such scanning microscopes use objective lens having small field of view and are therefore less expensive comparatively to the hereinbefore mentioned microscope. However, such microscopes take a long time or require complex methods in order to quickly scan the sample comparatively to the microscopes having a large field of view.

Thirdly, multi-spot microscopes form images by scanning the sample with a large number of spots, more precisely an array of spots. Such multi-spot microscopes generate images having a large field of view in a short time relatively to the scanning microscopes while being relatively inexpensive.

The imaging of samples like unstained samples or biological samples (e.g. single-celled organisms, tissue culture, etc. . . . ) is rendered difficult by the fact that such samples often have low intrinsic contrast. Low contrast means that the variations in absorption and refractive index across the plane defined by the sample are very small, typically a refractive index variation of the order of 10⁻². As a consequence, certain features of such samples remain invisible on the images.

Differential interference contrast (DIC) microscopy is known in the art and enables increasing the contrast of such samples. The DIC microscopy is based on the principle of interferometry. In DIC microscopes, a polarized light source is separated into two beams that take different paths through the sample and thus have different optical path lengths/phase, and that are further recombined resulting in an interference. Thus, in images obtained with DIC microscopes, the variation of optical density of the sample results in a visible change in darkness (appearance of physical relief) like a 3D object viewed under strong oblique illumination with strong light and dark shadow on the corresponding faces. However, the DIC microscopes have a complex optical structure involving in particular polarizing filters and Nomarsky-modified Wollaston prisms.

### SUMMARY OF THE INVENTION

It is an object of the invention to propose a method of imaging a sample that overcomes at least one of the drawbacks of the prior art. In particular, the invention aims at enhancing image contrast of samples comprising low intrinsic contrast features being imaged with a multi-spot scanning microscope.

According to a first aspect, the invention relates to a method of imaging a sample. The method comprises the steps of:
providing a reference array of spots,
illuminating the sample with the reference array of spots and acquiring at least one sample image comprising a sample related array of spots resulting from the reference array of spots interacting with the sample,
determining a spot characterizing parameter for each of a plurality of sample related spots, and
constructing an image of the sample by plotting the spot characterizing parameter for each of the plurality of sample related spots at the respective sample related spot position.

The method may comprise the steps of
scanning a relative position of the sample and the reference array of spots,
repeating the sample illumination step, the sample image acquisition step, and the spot characterizing parameter determination step, and
constructing an image of the sample by plotting the spot characterizing parameter for each of the plurality of sample related spots as a function of the relative position of the sample related array of spots and the reference array of spots.

The spot characterizing parameter determination step may comprise comparing between the reference array of spots and the imaged sample related array of spots by:
identifying reference spots in the reference array of spots,
identifying sample spots in the imaged sample related the array of spots, and
associating a plurality of identified sample spot with a corresponding identified reference spot.

According to a first embodiment, the determination of a spot characterizing parameter comprises the steps of:
determining a reference position for the plurality of identified spots within the imaged array of spots,
determining a sample position for the plurality of identified spots within the imaged sample related array of spots,
determining a displacement vector for a plurality of spots by calculating the difference between the reference position and the sample position of the plurality of associated spots.

The determination of a spot characterizing parameter may further comprise the step of calculating a magnitude or a phase or a component with respect to a Cartesian coordinate frame of the displacement vector.

The determination of the reference position for the plurality of identified spots within the imaged array of spots may comprise:
defining at least two reference positions,
determining the displacement vectors for the identified spots within the imaged sample related array of spots (IMO for the at least two reference positions,
calculating the average of the square of the magnitude of said displacement vectors, and
selecting the reference position with the minimum average of the square of the magnitude of the displacement vectors.

According to a second embodiment, the determination of a spot characterizing parameter for the plurality of spot comprises determining an alteration of the spot shape due to the reference array of spots interacting with the sample.

According to a third embodiment, the determination of a spot characterizing parameter for the plurality of spot comprises determining an alteration of the polarization due to the reference array of spots interacting with the sample.

According to a fourth embodiment, the method further comprises:
imaging the spots on a pixelated detector comprising a matrix of pixels,
grouping the pixels in areas,
associating an area with each sample spot, the pixels within the area being closest to the identified reference spot corresponding to the identified sample spot, and
determining the spot characterizing parameter by summing pixel intensities of each area.

According to a fifth embodiment, the method may further comprise the steps of:
imaging the spots on a pixelated detector comprising a matrix of pixels,
grouping the pixels in areas,
associating at least two areas with each sample spot, the pixels within the at least two areas being closest to the identified reference spot corresponding to the identified sample spot,
summing pixel intensities of each area, and
determining a spot characterizing parameter by taking the difference of the summed intensity of said two areas.

The area(s) associated with each spot may be a circle or a square. The area(s) may have a size substantially smaller than the spot diameter. More precisely, the circle may have a radius substantially smaller than the spot diameter, and the square may have a side substantially smaller than the spot diameter.

Optionally, the reference position for the plurality of identified spots within the imaged array of spots may be acquired during a calibration operation on a substantially uniform sample.

Advantageously, the invention applies to a multi-spot scanning microscope comprising:
an illumination source generating a beam,
a spot generator for generating a reference array of spots,
a microscope slide for supporting a sample,
a scanning means for scanning the array of spots across the slide by moving either the spot generator or the microscope slide,
an imaging means for imaging each spot having interacted with the sample on a pixelated detector, and
a processing and storing module coupled to the detector, the processing and storing module constructing an image of the sample by implementing the method of imaging a sample of the invention.

According to still a further aspect, the invention relates to a computer program product for imaging a sample by an imaging device, comprising a set of instructions that, when loaded into an internal memory of a processing and storing module of the imaging device, causes the processing and storing module to carry out the steps of:
determining a spot characterizing parameter for each of a plurality of sample related spots, the sample related array of spots being comprised in at least one sample image resulting from the reference array of spots interacting with the sample, and
constructing an image of the sample by plotting the spot characterizing parameter for each of the plurality of sample related spots at the respective sample related spot position.

Alternatively, the image of the sample construction may comprise plotting the spot characterizing parameter for each of the plurality of sample related spots as a function of a relative position of the sample related array of spots and the reference array of spots.

Optionally, the computer program product may also causes the processing and storing module to carry out the steps of the sample imaging method of the invention according to the first, the second, the third or the fourth embodiment as mentioned hereinbefore.

Thus, the invention enables high-contrast imaging of samples with a multi-spot scanning microscope, said samples comprising features that are nearly uniform in absorption and refractive index, such as biological samples. The invention enables imaging large fields at high resolution in short times, and in a very cost-effective manner. The invention may have particular applications in life-sciences, pathology, and minimal invasive systems for real time optical biopsy (e.g. cancer screening and early cancer detection based on fast in vitro DNA cytometry).

These and other aspects of the invention will be apparent from and elucidated with reference to the embodiments described hereinafter.

### BRIEF DESCRIPTION OF THE DRAWINGS

The present invention is illustrated by way of example and not limited to the accompanying figures, in which like references indicate similar elements:

FIG. 1 schematically depicts a multi-spot scanning microscope;

FIG. 2 is an enlarged view illustrating an image of an array of spots in the sample of the multi-spot scanning microscope FIG. 1;

FIG. 3 illustrates in a diagrammatic manner the principle of the imaging method of the invention;

FIG. 4 illustrates an image of a sample obtained with a multi-spot scanning microscope before applying the contrast enhancing method of the invention;

FIG. 5 illustrates an image of a sample obtained with a multi-spot scanning microscope after applying a first embodiment of the contrast enhancing method of the invention;

FIG. 6 illustrates an image of a sample obtained with a multi-spot scanning microscope after applying a fourth embodiment of the contrast enhancing method of the invention; and

FIGS. 7 to 10 schematically depict a spot on a portion of a pixelated detector illustrating the principle of the different embodiments of the invention.

### DETAILED DESCRIPTION OF THE INVENTION

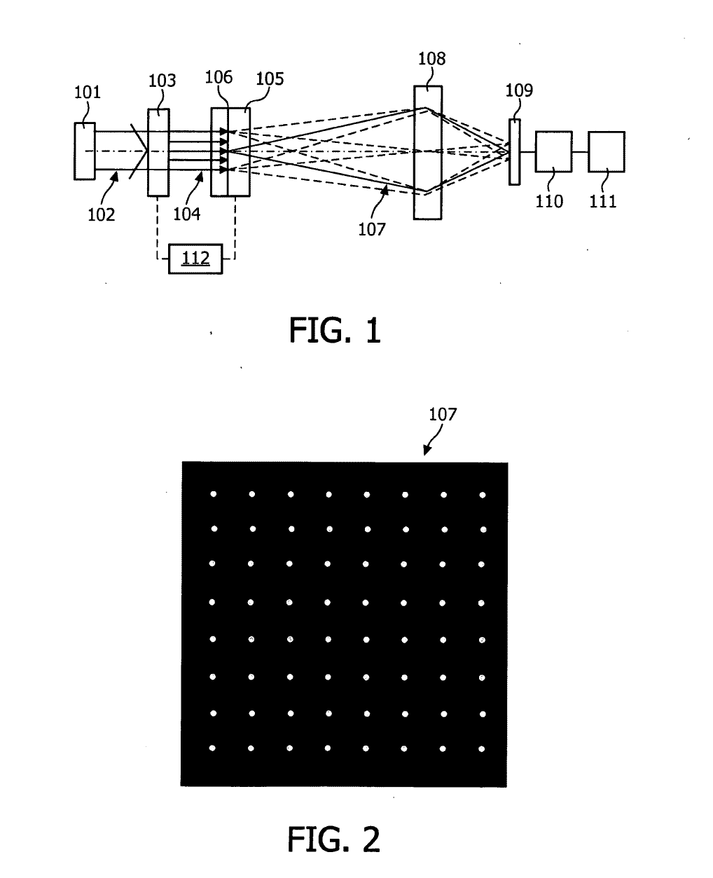

FIG. 1 schematically depicts a multi-spot scanning microscope. Typically, a multi-spot scanning microscope comprises an illumination source 101, a spot generator 103, a sample assembly 105 supporting a sample 106, an imaging means 108, a pixelated detector 109, a processing and storing module 110, a display 111 and a scanning means 112.

The illumination source 101 generates for example a parallel beam 102 directed towards the spot generator 103. The illumination source 101 may typically comprise a laser source, a lens, a beam splitter and forward sense photo-detector (these elements are not shown). The laser emits a beam that is collimated by the lens and incident on the splitter. The transmitted part is captured by the forward sense photo-detector for measuring the light output in order to control the light output via a laser driver. The reflected part is incident on the spot generator 103.

The spot generator 103 generates a reference array of spots 104 directed towards a sample assembly 105. For example, the spot generator 103 may be a diffractive structure like a hologram or a binary phase structure, or micro-lens arrays. For example, such a spot generator may generate several hundreds to several thousands of spots.

The sample assembly 105 comprises a cover slip, a sample layer and a microscope slide. The sample assembly 105 may support a sample 106, e.g. a biological sample. The scanning means 112 enables the array of spots to be scanned across the slide 105 by moving either the spot generator 103 or the sample assembly 105.

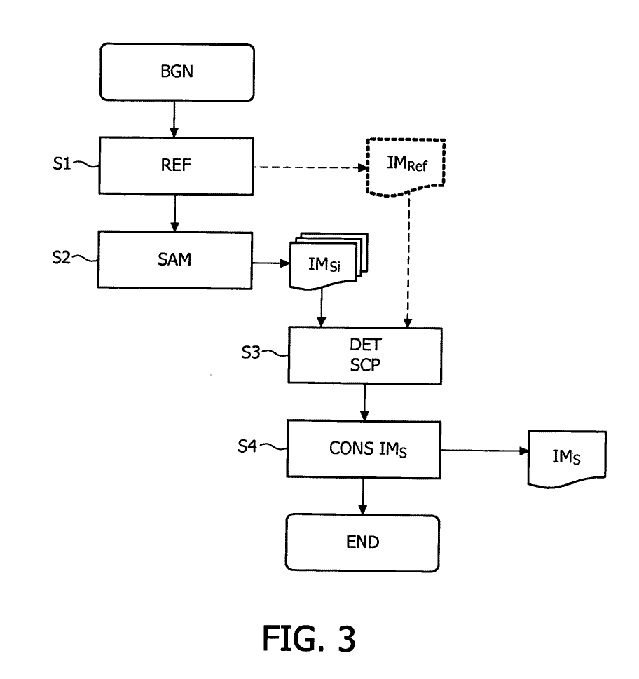

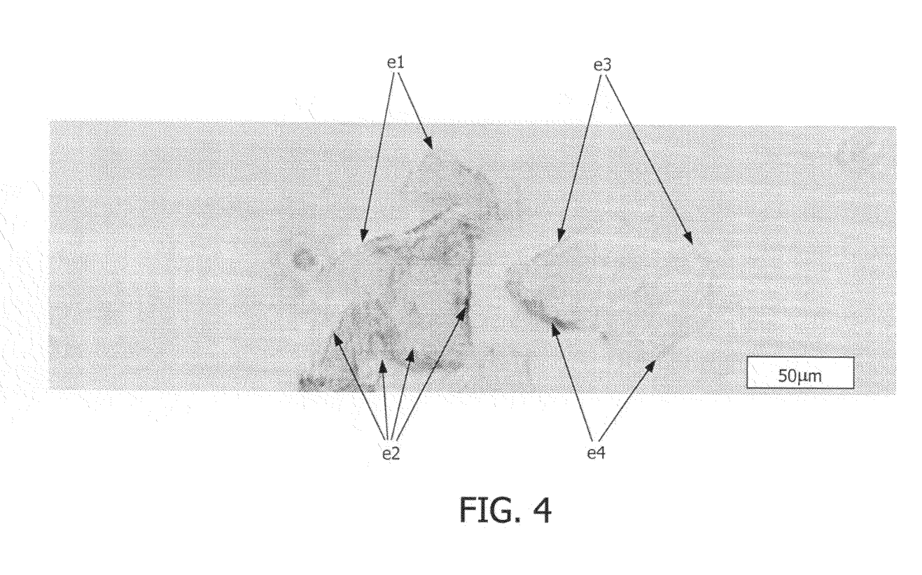

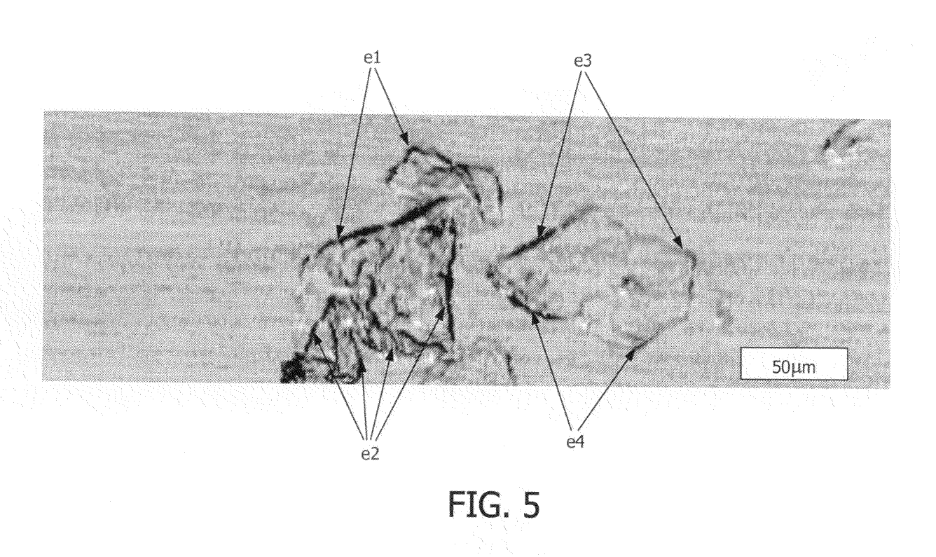

Because of the array of spots, the scan is only performed over the area in between the spots. The imaging means 108 may be focusing means positioned behind the sample assembly 105 for imaging each spot having interacted 107 with the sample 106 on the pixelated detector 109. FIG. 2 illustrates an image of an array of spots in the sample. The pixelated detector 109 may be for example a matrix of CMOS or CCD pixels. Advantageously, the pixelated detector 109 is such that, on the one hand, the number of pixels of the pixelated detector is substantially larger than the number of the spots in the array of spots and, on the other hand, the diameter of a spot on the array of pixels of the detector is substantially larger than at least two pixels. The processing and storing module 110 is coupled to the pixelated detector 109. For example, the processing and storing module 110 comprises a video processing integrated circuit and internal memory. The processing and storing module 110 implements the construction of images of the sample and also the imaging method of the invention that will be described hereinafter in relation with FIG. 3. The processing and storing module 110 is coupled to the display 111 for displaying the images of the sample. By scanning the spots over the sample and taking images at several positions, numerous images are gathered into the internal memory of the processing and storing module 110. The processing and storing module 110 combines all the images to a single high-resolution image of the sample. FIG. 4 illustrates an image of a sample that has been constructed from a series of images as depicted in FIG. 2 after scanning of the sample without applying the imaging method of the invention.

FIG. 3 illustrates in a diagrammatic manner the principle of the imaging method according to the invention.

In a first step S1, a reference array of spots (REF) is provided.

According to an alternative related to the first step S1, further to the provision of the reference array of spots, a reference image IM_{Ref} comprising the reference array of spots may also be acquired with the multi-spot scanning microscope (this alternative is indicated by dotted lines in FIG. 3). The reference image IM_{Ref} enables determining the nominal positions of the reference spots. During this alternative step, the microscope slide is empty and thus an image of a sample equivalent to a uniform transparent sample is acquired. The reference image may be acquired during a calibration operation. Such an operation may be performed during manufacturing of the microscope, or repeated in a regular manner. From the reference image, the nominal positions of the reference spots can be calculated.

In a second step S2, the sample is illuminated with the reference array of spots and at least one sample image IM_{S}; comprising a sample related array of spots is acquired with the multi-spot scanning microscope (SAM). The sample related array of spots results from the reference array of spots interacting with the sample in the microscope slide.

Alternatively, a plurality of sample image IM₅₁, IM_{S2}, IM_{S3}, IM_{Sn} may be acquired. This may be performed by scanning the relative position of the sample 106 and the reference array of spots 104. By acquiring a greater number of imaged sample related array of spots, a better image resolution can be achieved. Each image comprises another sample related array of spots at different positions in the sample resulting from the reference array of spots interacting with the sample.

In a third step S3, a spot characterizing parameter is determined (DET SCP) for a plurality of spots. The spot characterizing parameter depends on the variation in intensity and direction of the refractive index of the sample.

It is to be noted that the wording “a plurality of spots” may represent all the acquired spots, or a predetermined selection of the spots, or even a random selection of the spots, said selections being chosen so as to image at least a portion of the sample.

Firstly, the spot characterizing parameter is determined by comparing between the reference array of spots 104 and the imaged sample related array of spots IM_{Si} by reference and sample identification steps, and an association step. Firstly, the reference spots are identified in the reference array of spots 104. Then, the sample spots are identified in the imaged sample related the array of spots IM_{Si}. Finally, each of a plurality of identified sample spots is associated with a corresponding identified reference spot. Typically, this identification comprises four steps. In a first step, the pixels within the image having intensity larger than a threshold value are identified. In a second step, the adjacent pixels with large intensity are grouped, each group representing potential spots. In a third step, a square grid with the correct nominal pitch is overlaid on the image, thus partitioning the image in unit-cells. Each unit-cell is a square of size equal to the pitch. The square grid is preferably close to the grid formed by the nominal positions of the spots. In a fourth step, the spot with the highest intensity within each unit-cell is defined as the sample spot corresponding to reference spot of that unit-cell.

Secondly, a least mean squares method may be implemented in order to determine the reference spot positions from the sample related image. According to this method, at least two reference positions for the identified spots within the imaged reference array of spots are defined. Then, at least two displacement vectors for the plurality of identified spot within the imaged sample related array of spots are determined. The average of the square of the magnitude of the at least two displacement vectors are calculated. The reference position with the minimum average of the square of the magnitude of the displacement vectors is selected. By repeating this method the grid of nominal spot positions may be fitted through the imaged sample related the array of spots IM_{Si}.

Alternatively, when a reference image IM_{Ref} has been determined by calibration, the comparison step between the imaged reference array of spots and the imaged sample related array of spots may comprise reference and sample identification steps, and an association step. Firstly, reference spots in the imaged reference array of spots IM_{Ref} and also sample spots in the imaged sample related the array of spots IM_{Si} are identified. Then, a plurality of identified sample spots is associated with a corresponding identified reference spot.

When a plurality of sample image IM_{S1}, IM_{S2}, IM_{S3}, . . . IM_{Sn} are acquired, a plurality of spot characterizing parameter for a plurality of spots of each image may be determined.

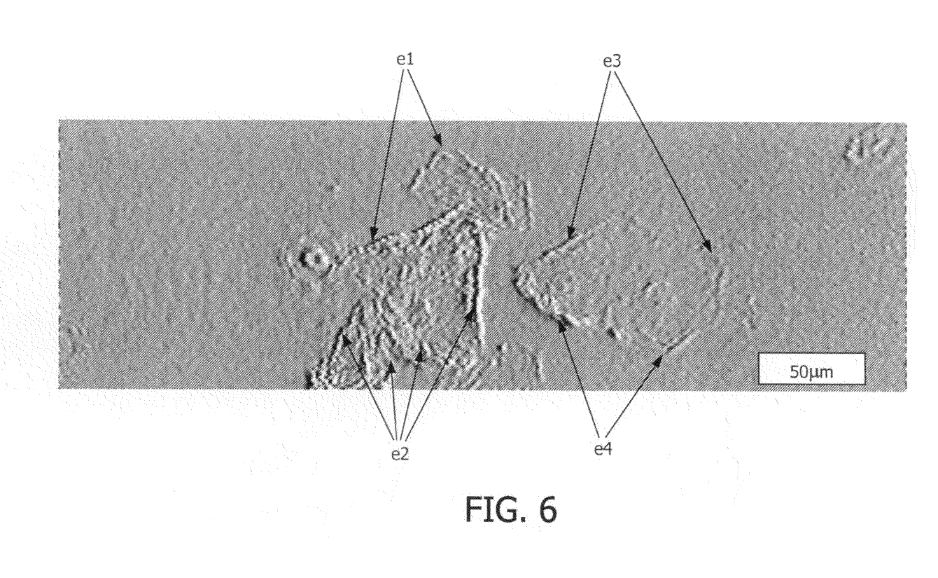

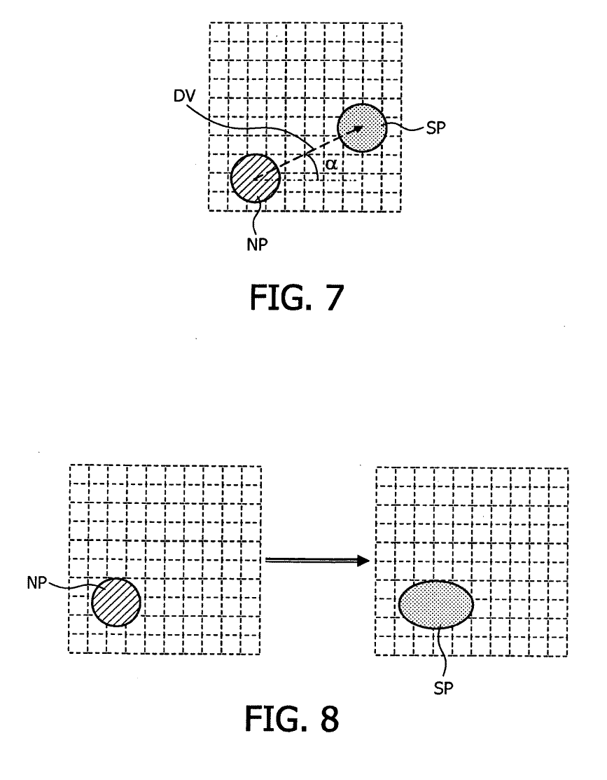

In a fourth step S4, the image of the sample is constructed at the respective spot position (CONS IM_{S}) in function of the spot characterizing parameter. The constructed image corresponds to an image of the sample IM_{S} having an enhanced contrast. More precisely, the image of the sample IM_{S} is constructed by plotting the spot characterizing parameter as a function of the position of the spot in the image. Thus, when comparing a sample image obtained without applying the method of the invention as depicted in FIG. 4, and a sample image obtained with the method of the invention as depicted in FIGS. 5 and 6, the intensity of a plurality of pixels of the image on the display is modified in function of the spot characterizing parameter. This results in a high-contrast sample image.

When a plurality of sample image IM_{S1}, IM_{S2}, IM_{S3}, . . . IM_{Sn} are acquired in order to improve the resolution, the image of the sample is constructed by plotting the spot characterizing parameter for a plurality of sample related spots as a function of the relative position of the sample related array of spots and the reference array of spots.

Now, the spot characterizing parameter determination of the third step and the image construction step of the fourth step will be described in a detailed manner with reference to various embodiments and alternatives.

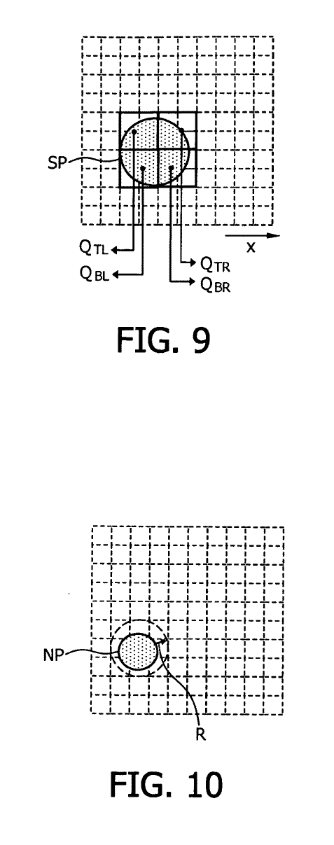

According to a first embodiment, the spot characterizing parameter determination for the plurality of spot comprises determining the position shift between a reference position and a sample position. FIG. 7 schematically illustrates the position shift of a spot on a portion of a pixelated detector between a nominal position NP and a sample position SP. More precisely, for the plurality of spot a displacement vector DV from the reference array of spots to the sample related array of spots is calculated. The reference position for the plurality of identified spot within the reference array of spots and the sample position for the plurality of identified spot within the imaged sample related array of spots are determined. Then, the displacement vector for a plurality of spot is determined by calculating the difference between the reference position and the sample position of the plurality of associated spot.

According to a first alternative, the image construction step depends on the magnitude DV of the displacement vector. The magnitude of the displacement vector is correlated to the value of the refractive index variation. For example, FIG. 5 illustrates an image of the sample after applying the imaging method of the invention according to the first alternative to the image of FIG. 4. It is to be noted that the edges e1, e2, e3, e4 of the different features are clearer in comparison to the ones of FIG. 4.

According to a second alternative, the image construction step depends on the phase of the displacement vector, namely the angle of the displacement vector. The phase of the displacement vector is correlated to the direction of the refractive index variation.

According to a third alternative, the image construction step depends on a component of the displacement vector with respect to a Cartesian coordinate frame.

Images similar to the one shown in FIG. 5 may be obtained with the alternative embodiments hereinbefore described.

According to a second embodiment, the spot characterizing parameter determination for the plurality of spots comprises determining for the plurality of spots an alteration of the spot shape due to the reference array of spots interacting with the sample. The alteration may be for example the deviation from the circular symmetry of the spot shape. The alteration of the spot shape may be measured by determining the height and/or the width in at least one direction of the spot. FIG. 8 schematically depicts a spot on a portion of a pixelated detector and illustrates the alteration (e.g. longitudinal elongation) of a spot between a nominal position NP and a sample position SP.

According to a third embodiment, the spot characterizing parameter determination for the plurality of spots comprises determining for the plurality of spots an alteration of the polarization due to the reference array of spots interacting with the sample. The alteration may be for example due to birefringence in the sample. The alteration of the polarization may be measured by adding a polarization filter to the detection light path.

According to a fourth embodiment, the spot characterizing parameter determination for the plurality of spots comprises summing the pixels intensity of areas associated with the plurality of spots. More precisely, an area of grouped pixels of the pixelated detector is associated with the plurality of sample spots. The areas are defined such that the pixels within the area are the closest to the identified reference spot corresponding to the identified sample spot. The spot characterizing parameters are determined by summing pixel intensities of each area. For example, the intensity of a group of pixels forming areas within a distance to the nearest nominal spot NP position less than a determined number R are added to construct an image. The determined number R is a radius which is advantageously less than the nominal size of a spot on the pixelated detector. FIG. 10 schematically depicts a spot on a portion of a pixelated detector illustrating the third embodiment of the invention. This embodiment emulates a confocal image, which is a scanning microscope image that is obtained by focusing the beam that returns from the sample onto a tiny aperture, a so-called pinhole. The advantage of this embodiment is that light emanating from the sample from depths different from the depth where the incident beam is focused on is filtered out at the pinhole. Therefore, this embodiment enables the microscope having resolution in the depth direction.

According to a fifth embodiment, the spot characterizing parameter determination for the plurality of spots comprises differentiating the pixels intensity of areas associated with the plurality of spots. More precisely, at least two areas of grouped pixels of the pixelated detector are associated with the plurality of sample spots. The areas are defined such that the pixels within the two areas are the closest to the identified reference spot corresponding to the identified sample spot. The pixel intensities of each area are summed. The spot characterizing parameters are determined by differentiating the summed intensity of the two areas. As an example, the spot characterizing parameter determination comprises differentiating the intensity of the plurality of spot with respect to a horizontal direction x of the image. The spot may be imaged on four groups of adjacent pixels forming four quadrants, a top left quadrant Q_{TL}, a top right quadrant Q_{TR}, a bottom left quadrant Q_{BL} and a bottom right quadrant Q_{BR}. For example, FIG. 9 schematically depicts a spot in a sample position SP on a portion of a pixelated detector that is imaged on four quadrants Q_{TL}, Q_{TR}, Q_{BL}, Q_{BR}. The differential intensity measured between said adjacent quadrants can be used to generate a sample image of high contrast. FIG. 6 shows an image constructed based on the image in FIG. 4 by applying the method according to the fourth embodiment of the invention and differentiating the intensity with respect to the horizontal direction. It is to be noted that the image of FIG. 6 is more detailed and has a better signal to noise ratio in comparison to the image of FIG. 4.

A combination of the different embodiments/alternatives may be implemented in order to construct the image of the sample. Further, the different embodiments/alternatives may be implemented in combination with any conventional techniques enabling enhancing the contrast of a sample image.

### Final Remarks

The drawings and their description hereinbefore illustrate rather than limit the invention.

There are numerous ways of implementing functions or method steps that have been described by means of items of hardware or computer program product (software), or both. In this respect, the drawings are very diagrammatic, each representing only one possible embodiment of the invention. Thus, although a drawing shows different functions as different blocks, this by no means excludes that a single item of hardware or software carries out several functions. Nor does it exclude that an assembly of items of hardware or software or both carry out a function.

Any reference sign in a claim should not be construed as limiting the claim. The word “comprising” does not exclude the presence of other elements than those listed in a claim. The word “a” or “an” preceding an element does not exclude the presence of a plurality of such element.

1. A method of imaging a sample comprising the steps of:
a) providing (S1) a reference array of spots (104),
b) illuminating the sample (106) with the reference array of spots (104) and acquiring (S2) at least one sample image (IM_{Si}) comprising a sample related array of spots (107) resulting from the reference array of spots interacting with the sample (106),
c) determining (S3) a spot characterizing parameter for each of a plurality of sample related spots, and
d) constructing (S4) an image of the sample (IM_{S}) by plotting the spot characterizing parameter for each of the plurality of sample related spots at the respective sample related spot position.

2. A method of imaging a sample according to claim 1, wherein the method further comprises the steps of:
e) scanning a relative position of the sample (106) and the reference array of spots (104),
f) repeating the sample illumination step, the sample image acquisition step, and the spot characterizing parameter determination step, and
g) constructing (S4) an image of the sample (IM_{S}) by plotting the spot characterizing parameter for each of the plurality of sample related spots as a function of the relative position of the sample related array of spots (107) and the reference array of spots (104).

3. A method of imaging a sample according to claim 1, wherein the spot characterizing parameter determination step comprises comparing between the reference array of spots (104) and the imaged sample related array of spots (IM_{Si}) by:
identifying reference spots in the reference array of spots (104),
identifying sample spots in the imaged sample related the array of spots (IM_{Si}), and
associating a plurality of identified sample spots with a corresponding identified reference spot.

4. A method of imaging a sample according to claim 3, wherein determining a spot characterizing parameter comprises the steps of:
determining the reference position for the plurality of identified spots within the imaged array of spots (IM_{Si}),
determining a sample position for the plurality of identified spots within the imaged sample related array of spots (IM_{Si}),
determining a displacement vector (DV) for a plurality of spots by calculating the difference between the reference position and the sample position of the plurality of associated spots.

5. A method of imaging a sample according to claim 4, wherein determining the spot characterizing parameter further comprises the step of calculating a magnitude or a phase or a component with respect to a Cartesian coordinate frame of the displacement vector (DV).

6. A method of imaging a sample according to claim 4, wherein determining the reference position for the plurality of identified spots within the imaged array of spots (IM_{Si}) comprises the steps of:
defining at least two reference positions,
determining the displacement vectors for the identified spots within the imaged sample related array of spots (IM_{Si}) for the at least two reference positions,
calculating the average of the square of the magnitude of said displacement vectors, and
selecting the reference position with the minimum average of the square of the magnitude of the displacement vectors.

7. A method of imaging a sample according to claim 3, wherein determining the spot characterizing parameter comprises the step of determining an alteration due to the reference array of spots interacting with the sample, of either the shape or the polarization of said spot.

8. A method of imaging a sample according to claim 3, wherein the method further comprises the steps of:
imaging the spots on a pixelated detector defining a matrix of pixels,
grouping the pixels in areas,
associating an area with each sample spot, the pixels within the area being the closest to the identified reference spot corresponding to the identified sample spot, and
determining the spot characterizing parameter by summing pixel intensities of each area.

9. A method of imaging a sample according to claim 3, wherein the method further comprises the steps of:
imaging the spots on a pixelated detector defining a matrix of pixels,
grouping the pixels in areas,
associating at least two areas with each sample spot, the pixels within the at least two areas being the closest to the identified reference spot corresponding to the identified sample spot,
summing pixel intensities of each area, and
determining a spot characterizing parameter by taking the difference of the summed intensity of said at least two areas.

10. A method of imaging a sample according to claim 8, wherein the at least one area associated with each spot is a circle or a square, and/or has a size substantially smaller than the diameter of the sample spot.

11. A method of imaging a sample according to claim 3, wherein the reference position for the plurality of identified spots within the imaged array of spots (IM_{Si}) is acquired during a calibration operation on a substantially uniform sample.

12. A multi-spot scanning microscope comprising:
an illumination source (101) generating a beam (102),
a spot generator (103) for generating a reference array of spots (104),
a microscope slide (105) for supporting a sample (106),
a scanning means (112) for scanning the array of spots across the slide by moving either the spot generator (103) or the microscope slide (105),
an imaging means (108) for imaging each spot having interacted (107) with the sample (106) on a pixelated detector (109),
a processing and storing module (110) coupled to the detector (109),
wherein the processing and storing module (110) construct an image of the sample by implementing the method of imaging a sample according to claim 1.

13. A computer program product for imaging a sample by an imaging device, comprising a set of instructions that, when loaded into an internal memory of a processing and storing module (110) of the imaging device, causes the processing and storing module to carry out the steps of:
determining (S3) a spot characterizing parameter for each of a plurality of sample related spots, the sample related array of spots being comprised in at least one sample image resulting from the reference array of spots interacting with the sample, and
constructing (S4) an image of the sample (IM_{S}) by plotting the spot characterizing parameter for each of the plurality of sample related spots at the respective sample related spot position.

14. A computer program product according to claim 13, wherein constructing (S4) the image of the sample (IM_{S}) comprises plotting the spot characterizing parameter for each of the plurality of sample related spots as a function of a relative position of the sample related array of spots (107) and the reference array of spots (104).

15. A computer program product for imaging a sample by an imaging device, comprising a set of instructions that, when loaded into an internal memory of a processing and storing module (110) of the imaging device, causes the processing and storing module to carry out the steps of:
determining (S3) a spot characterizing parameter for each of a plurality of sample related spots, the sample related array of spots being comprised in at least one sample image resulting from the reference array of spots interacting with the sample,
constructing (S4) an image of the sample (IM_{S}) by plotting the spot characterizing parameter for each of the plurality of sample related spots at the respective sample related spot position, and wherein the set of instructions further causes the processing and storing module to carry out the steps of the method of imaging a sample according to claim 3.
